(19) United States
(12) Patent Application Publication
(10) Pub. No.: US 2007/0184221 A1
(43) Pub. Date: Aug. 9, 2007

(54) Barrier laminate containing partially aromatic nylon materials, blank constructed from the barrier laminate, and container constructed from the barrier laminate

(76) Inventor: Tricia Susan Reighard, Loveland, OH (US)

Correspondence Address: HASSE & NESBLITT, LLC, 8837 CHAPEL SQUARE DRIVE, SUITE C, CINCINNATI, OH, 45249, US

(21) Appl. No.: 11/348,794

(22) Filed: Feb. 7, 2006

(51) Int. Cl. B32B 27/10

(52) U.S. Cl. 428/34.2

(57) ABSTRACT

Laminate structures provide an oxygen barrier for use in packaging of liquid and non-liquid (dry) products: preferably, fruits, citrus juices, teas, other beverages, and the like. The laminate structures contain at least one oxygen barrier layer of a partially aromatic nylon. Particularly useful partially aromatic nylons are those utilizing MXD6/MXDI chemistry. The partially aromatic nylon layer provides an oxygen barrier comparable to ethylene vinyl alcohol copolymer (EVOH) when used at high relative humidities. The partially aromatic nylon layer simplifies laminate structure and saves materials costs.

### BACKGROUND OF THE INVENTION

1. Field of the Invention

The invention relates to partially aromatic nylon materials used for oxygen barriers in packaging.

2. Description of the Related Art

Ethylene vinyl alcohol copolymer (EVOH) is an outstanding oxygen barrier material at relative humidities (RH) below approximately 60%. However, between 60% and 100% RH, the oxygen permeability of the material increases significantly such that the oxygen barrier at 100% RH is roughly two orders of magnitude poorer than at 60% RH.

EVOH has been used in laminates for beverage packaging applications since the mid-1980's. In juice packaging, the oxygen barrier slows the ingress of oxygen into the carton, thereby slowing the rate of vitamin C, color, and aroma/flavor degradation.

Recent modeling and experimental studies have shown that, in many common laminate structures, the relative humidity experienced by the EVOH layer may be as high as 98% RH. As described above, the oxygen barrier performance of EVOH at high relative humidity such as this is much poorer than at low RH.

Specialty nylons are known in the market place. “Specialty nylons” are defined to include amorphous, amorphous/semi-crystalline blends, and partially aromatic nylon materials. Some common examples of specialty nylons include meta-xylene diamine (MXD6) such as that sold under the trade name MX-NYLON from Mitsubishi Gas Chemical (New York, N.Y.) and amorphous 6I/6T nylon such as that sold under the trade name G21 from EMS-CHEMIE (North America), Inc. (Sumter, S.C.). A new partially aromatic nylon material based on MXD6/MXDI chemistry was recently introduced by EMS-CHEMIE (North America), Inc. (Sumter, S.C.). Prior to the invention, partially aromatic nylon materials based on MXD6/MXDI chemistry have not been evaluated by extrusion coating for barrier laminate applications.

### SUMMARY OF THE INVENTION

It is accordingly an object of the invention to provide a barrier laminate containing partially aromatic nylon materials, a blank constructed from the barrier laminate, and a container constructed from the barrier laminate that overcome the hereinafore-mentioned disadvantages of the heretofore-known devices of this general type and that provide an improved materials for use in food containers.

An improved method for creating a laminate structure with excellent oxygen barrier involves the use of specialty nylon materials. “Specialty nylons” are defined to include amorphous, amorphous/semi-crystalline blends, and partially aromatic nylon materials. These materials show considerably less barrier dependence on relative humidity than EVOH does. In fact, the oxygen transmission rate holds virtually constant across the range of 80-100% RH.

The following are examples of suitable specialty nylons. Meta-xylene diamine (MXD6) is sold under the trade name MX-NYLON from Mitsubishi Gas Chemical (New York, N.Y.). Amorphous 6I/6T nylon is available under the trade name G21 from EMS-CHEMIE (North America), Inc. (Sumter, S.C.). A new partially aromatic nylon material based on MXD6/MXDI chemistry is sold by EMS-CHEMIE (North America), Inc. (Sumter, S.C.).

An object of the present invention is to provide improved heat-sealable barrier laminate materials for use in a variety of food packaging.

A further object of the invention is to provide improved, heat-sealable barrier laminate materials for a juice carton that exhibits a substantial barrier to the loss of vitamin C and has performance equal to or better than that of conventionally used polymer barrier laminates.

Still another object of the invention is to provide improved, heat-sealable barrier laminate materials for fruit or citrus juices, teas, other beverages, and the like, as well as non-liquid (dry) products. The barrier laminate materials should be easy to manufacture and provide reliable performance in the field, including a high degree of flavor, color, and vitamin protection across the product's shelf life.

In accordance with the invention, laminate structures are described. The laminate structure contains at least one oxygen barrier layers of a partially aromatic nylon, in particular, a partially aromatic nylon that utilizes MXD6/MXDI chemistry. The laminates can be used for liquid and non-liquid (dry) products, preferably for fruit or citrus juices, tea, other beverages, and the like. The partially aromatic nylon layer(s) provides oxygen barrier comparable to EVOH when used at high relative humidities, allowing laminate structure simplification and materials cost savings.

With the foregoing and other objects in view, there is provided, in accordance with the invention, an oxygen barrier laminate. The barrier laminate includes a barrier layer, a polyolefin layer, and a tie layer. The barrier layer is composed of a partially aromatic nylon. The tie layer is composed of an adhesive tie material and bonds the barrier layer and the layer of polyolefin.

In accordance with a further object of the invention, the barrier layer includes an MXD6/MXDI material. In particular, the barrier layer may include a blend of MXD6/MXDI and nylon 6.

In accordance with a further object of the invention, the tie layer can be an ethylene-based copolymer modified with maleic anhydride functional groups.

In accordance with a further object of the invention, the polyolefin layer can be polyethylene, in particular low-density polyethylene.

With the objects of the invention in view, there is also provided an oxygen barrier laminate that includes a paperboard substrate, two polyolefin layers, a partially aromatic nylon layer, and a tie layer. The paperboard substrate has an exterior and an interior surface. A first polyolefin layer is coated on the exterior surface of the paperboard substrate. The partially aromatic nylon layer is coated on the interior surface of the paperboard substrate. The tie layer is composed of an adhesive material. The second polyolefin layer forms a product contact surface.

With the objects of the invention in view, there is also provided a blank. The blank can be used for producing a container for juices, tea, and other beverages. The blank is formed the laminates described above.

With the objects of the invention in view, there is also provided a container for juices, tea, and other beverages constructed from the above-described laminates.

Other features that are considered as characteristic for the invention are set forth in the appended claims.

Although the invention is illustrated and described herein as embodied in a barrier laminate containing partially aromatic nylon materials, a blank constructed from the barrier laminate, and a container constructed from the barrier laminate, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic sectional view of an embodiment of a barrier laminate layer having a single barrier layer.

FIG. 2 is a sectional view of an embodiment of a barrier laminate having two barrier layers.

FIG. 3 is a sectional view of an embodiment of a barrier laminate having three barrier layers.

FIG. 4 is a sectional view of an embodiment of a barrier laminate having a specialty nylon barrier layer disposed closer to a paperboard substrate than an oxygen barrier layer.

FIG. 5 is a sectional view of an embodiment of a barrier laminate having an oxygen barrier layer disposed closer to a paperboard substrate than a specialty nylon barrier layer.

FIG. 6 is a sectional view of an embodiment of a barrier laminate having a specialty nylon barrier layer between polyolefin layers.

FIG. 7 is a sectional view of an embodiment of a barrier laminate wherein at least one of three barrier layers is made from specialty nylon.

FIG. 8 is a graph plotting percentage of vitamin C retained versus days after filling for refrigerated cartons of orange juice.

FIG. 9 is a graph plotting carton bulge versus days after filling for refrigerated cartons of skim milk.

FIG. 10 is a graph plotting percentage of vitamin C retained versus days after filling for refrigerated cartons of orange juice.

### DESCRIPTION OF THE PREFERRED EMBODIMENTS

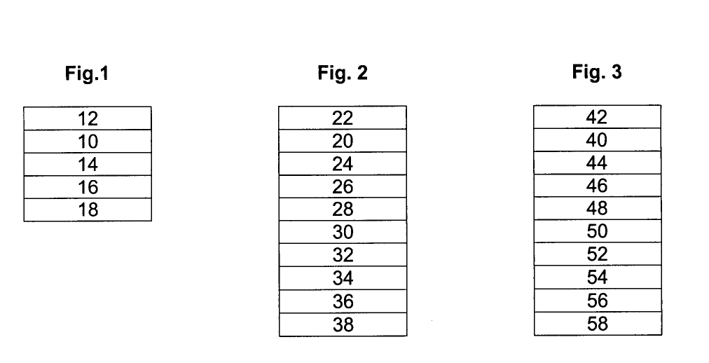

Referring now to the figures of the drawings in detail and first, particularly to FIG. 1 thereof, there is shown a laminate containing a specialty nylon material with oxygen barrier properties that can compete with ethylene vinyl alcohol copolymer (EVOH) at the conditions of use. All weights given for particular laminate layers are expressed in pounds per three thousand square feet (lbs/3000 ft²).

In FIG. 1, the paperboard substrate 10 has a weight of 100-300 lbs. Applied on one side of the paperboard substrate 10 is an outer “gloss” layer 12. Coating weight of the outer gloss layer 12 may range from about 5-20 lbs. and is preferably about 12 lbs. Preferably, the polyolefin polymer is polyethylene and most preferably, a low-density polyethylene such as those sold under the trade names TENITE 1924P, which is available from Eastman/Voridian (Kingsport, Tenn.) or CHEVRON 4517 from Chevron Phillips Chemical Co. (Houston, Tex.).

A specialty nylon oxygen barrier layer 14 is formed from a partially aromatic nylon. In the preferred embodiment, the partially aromatic nylon utilizes MXD6/MXDI chemistry. A preferred supplier of this material is EMS-CHEMIE (North America), Inc. (Sumter, S.C.). The partially aromatic nylon material can be blended with other nylons such as nylon 6, nylon 66, nylon 10, nylon 6-10, and nylon 12; amorphous nylon; amorphous/semi-crystalline blends; other partially aromatic nylons including MXD6 based materials; and nylon nanocomposites. Some preferred blending materials include nylons sold under the trade name HONEYWELL H73QP NYLON 6 (Morristown, N.J.), GRIVORY G21 AMORPHOUS NYLON from EMS-CHEMIE (North America), Inc. (Sumter, S.C.), MITSUBISHI GAS CHEMICAL MX-NYLON MXD6 (New York, N.Y.), and HONEYWELL NC73ZP NYLON 6 NANOCOMPOSITE (Morristown, N.J.). Other possible blending materials include inorganic fillers such as calcium carbonate or talc and ethylene vinyl alcohol copolymer (EVOH). Coating weight may range from about 0.5-20 lbs., preferably about 3-8 lbs., and most preferably about 5 lbs.

In addition to providing an oxygen barrier, a specialty nylon oxygen barrier layer 14 is expected to provide mechanical strength and thermal resistance. The qualities lead to distribution abuse resistance and bulge resistance of the laminate.

A tie layer 16 is used to adhere the polar nylon layer to a nonpolar polyolefin layer 18. Coating weight of the tie layer 16 may range from about 0.5-15 lbs. but in most cases will be about 1.5 lbs. to minimize cost yet attain acceptable levels of adhesion. The tie layer 16 is preferably based on, but not limited to, ethylene-based copolymers modified with maleic anhydride functional groups such as those sold under the trade name PLEXAR 5125, which is produced by MSI Technologies (Arlington Heights, Ill.).

The inner “product contact” layer 18 has a coating weight of about 1-30 lbs., preferably about 10-20 lbs., and most preferably about 14 lbs. Preferably, the polyolefin polymer is polyethylene and most preferably, a low-density polyethylene such as that sold under the trade name TENITE 1924P available from Eastman/Voridian (Kingsport, Tenn.) and CHEVRON 4517 from Chevron Phillips Chemical Co. (Houston, Tex.).

The laminate of FIG. 1 would be produced by coating one side of the paperboard substrate 10 with gloss layer 12 followed by coating the other side of the substrate with a coextrusion of the oxygen barrier layer 14, tie layer 16, and product contact layer 18. While this method is a preferred method of producing the laminate of FIG. 1, other methods are possible and are within the scope of the invention

Referring to FIG. 2, an alternate preferred embodiment is shown. The paperboard substrate 20 and outer gloss layer 22 are comparable to the paperboard substrate 10 and outer gloss layer 12 in FIG. 1. A “barrier 1,” layer 24 may include a standard polyamide such as nylon 6, nylon 66, nylon 10, nylon 6-10, or nylon 12. Coating weight may be about 0.5-20 lbs., and preferably about 5 lbs. An appropriate nylon 6 material is sold under the trade name HONEYWELL H73QP from Honeywell Plastics (Morristown, N.J.). Conversely, barrier 1 layer 24 may be a specialty nylon layer as described for the barrier layer 14 in FIG. 1. Again, the coating weight may be about 0.5-20 lbs., and preferably about 5 lbs.

Three tie layers 26, 32, and 36 are similar to the tie layer 16 of FIG. 1. Preferable coat weight of each layer is about 1.5 lbs. Layer 28 is a “caulking” layer in the laminate. Coating weight may be about 6-30 lbs., and preferably about 12-18 lbs. Preferably the “caulking” layer is a polyolefin; more preferably it is a polyethylene, and most preferably, a low-density polyethylene. The caulking layer 28 melts to some extent during subsequent heating steps to fill channels that form when the laminate is folded into a package.

A polyolefin layer 30 is provided. Preferably, the polyolefin is polyethylene, and most preferably, a low-density polyethylene. Coating weight is about 1-12 lbs., and preferably about 4-8 lbs. A “barrier 2” layer 34 may be composed of a specialty nylon layer as described in detail for barrier layer 14 of FIG. 1. However, if Barrier 1 layer 24 is formed from a specialty nylon layer, then barrier 2 layer 34 may or may not also be a specialty nylon layer. Coating weight is about 0.5-5 lbs., and preferably about 2-3 lbs.

If barrier 2 layer 34 does not contain specialty nylon, it may instead contain:
(a) EVOH (containing 25-48 mole % ethylene), oxygen scavenging EVOH materials, EVOH nanocomposites, EVOH combined with other inorganic fillers (such as talc or kaolin), or blends of EVOH with other polymers (such that EVOH remains the continuous phase);
(b) polyvinyl alcohols (PVOH);
(c) polyamides such as nylon 6, nylon 66, nylon 10, nylon 6-1 0, nylon 12, nylon combined with inorganic fillers (such as talc or kaolin), and blends of nylon with other polymers (such that nylon remains the continuous phase);
(d) polyethylene terephthalates (PET) including glycol-modified PET, acid-modified PET, PET nanocomposites, PET combined with other inorganic fillers (such as talc or kaolin), and blends of PET with other polymers (such that the PET remains the continuous phase); or
(e) polyolefins including low-density polyethylene, high-density polyethylene, linear low-density polyethylene, polypropylene, cyclic olefin copolymers and blends thereof, polycarbonates, and liquid crystal polymers

Finally, layer 38 is the inner “product contact” layer. Coating weight is about 1-12 lbs., and preferably about 4-8 lbs. The product contact layer 38 is preferably a polyolefin, more preferably, a polyethylene, and most preferably, a low-density polyethylene such as those sold under the trade name TENITE 1924P available from Eastman/Voridian (Kingsport, Tenn.) and CHEVRON 4517 from Chevron Phillips Chemical Co. (Houston, Tex.).

The laminate of FIG. 2 could be produced by coating one side of the paper board substrate 20 with gloss layer 22 followed by coating of the other side of the substrate 20 with a coextrusion coating of barrier 1 layer 24, tie layer 26, and caulking layer 28 at one station to which a second coextrusion coating of the polyolefin layer 30, tie layer 32, barrier 2 layer 34, and tie layer 36, and inner product contact layer 38 is applied at a second station. While this method is preferred, the method is just one of many possible ways of producing the laminate of FIG. 2 that are encompassed within the scope of the invention.

Referring to FIG. 3, another alternate embodiment of a laminate is shown. Paperboard substrate 40 and outer gloss layer 42 are consistent with paperboard substrate 10 and outer gloss layer 12, respectively, of the laminate in FIG. 1.

Polyolefin layer 50, tie layer 52, tie layer 56, and inner product contact layer 58 are consistent with polyolefin layer 30, tie layer 32, tie layer 36, and inner product contact layer 38, respectively, in the laminate of FIG. 2.

Layers 44, 46, and 54 are the barrier layers. Any combination of these barrier layers 44, 46, and 54 may contain specialty nylon (as defined by layer 14 of the laminate in FIG. 1) as long as at least one of the barrier layers 44, 46, or 54 does. When the layer is not selected as a specialty nylon layer, any of the materials listed above for barrier 2 layer 34 of the laminate of FIG. 2 (when it is not a specialty nylon layer) may be used. There may be an advantage to using a polyamide such as nylon 6 in barrier layer 44 for the mechanical strength and thermal abuse resistance provided to the laminate by these materials.

A coating weight of barrier layer 44 is about 0.5-20 lbs., and preferably about 5 lbs. A coating weight of barrier layer 46 is about 0.5-10 lbs., and preferably about 3-6 lbs. A coating weight of barrier layer 54 is about 0.5-5 lbs, and preferably about 2-3 lbs.

A tie layer 48 is preferably based on, but not limited to, ethylene-based copolymers modified with maleic anhydride functional groups such as those sold under the trade name PLEXAR 5125 produced by MSI Technologies. Coating weight is about 0.5-15 lbs., and in this case, preferably about 8 lbs., which is somewhat thicker than all of the preferred tie layer thicknesses listed above. The tie layer 48 has a distinct, primary role to play as a tie layer, but also serves to some extent as a caulking layer and therefore the need for the greater layer thickness.

The laminate of FIG. 3 could be produced by coating one side of the paperboard substrate 40 with outer gloss layer 42 followed by coating the other side of the paperboard substrate 40 with a coextrusion coating of barrier layer 44, barrier layer 46, and tie layer 48 at one station to which a second coextrusion coating of polyolefin layer 50, tie layer 52, barrier layer 54, tie layer 56, and inner product contact layer 58 is applied at a second station. While this is the preferred method of making the laminate according to FIG. 3, other methods are possible and are within the scope of the invention.

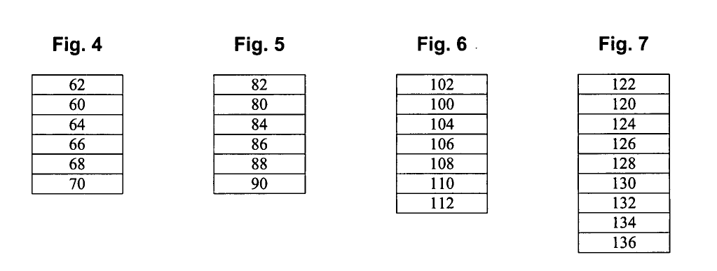

Additional alternate embodiments of the invention are shown in FIGS. 4, 5, 6, and 7. Referring to FIG. 4, a paperboard substrate 60, outer gloss layer 62, barrier layer 66, tie layer 68, and nonpolar polyolefin layer 70 are consistent with layers 10, 12,14, 16, and 18, respectively, in the laminate of FIG. 1. An oxygen barrier layer 64 is not specialty nylon. Coating weight of the oxygen barrier layer 64 is about 0.5-20 lbs., and preferably about 5 lbs. Acceptable materials are consistent with those defined for barrier 2 layer 34, sections (a), (b), (c), and (d) of FIG. 2. All of these barrier materials exhibit some degree of sensitivity to relative humidity. The use of a specialty nylon in barrier layer 66, which exhibits minimal dependence on relative humidity, may act as a barrier to moisture transfer into the more sensitive material of barrier layer 64, resulting in enhanced oxygen barrier performance overall. A polyamide would be a particularly preferred material. The use of a polyamide, and specifically nylon 6, has been proven to provide mechanical abuse resistance to the laminate by preventing pinholing from moisture in the basestock.

The laminate of FIG. 4 would be produced by coating one side of the paperboard substrate 60 with outer gloss layer 62 followed by coating the other side of the substrate 60 with a coextrusion of oxygen barrier layer 64, specialty nylon oxygen barrier layer 66, tie layer 68, and inner product layer 70. While this is the preferred method of producing the laminate of FIG. 4, other methods are possible and are within the scope of the invention.

Referring to FIG. 5, a paperboard substrate 80, outer gloss layer 82, specialty nylon oxygen barrier layer 84, tie layer 88, and inner product contact layer 90 are consistent with layers 10,12, 14, 16, and 18, respectively, in the laminate of FIG. 1. An oxygen barrier layer 86 is not a specialty nylon. Coating weight of layer 86 is about 0.5-8 lbs., and preferably about 2-5 lbs. Acceptable materials are consistent with those defined for FIG. 2, barrier 2 layer 34, sections (a), (b), (c), and (d).

The laminate of FIG. 5 would be produced by coating one side of the paperboard substrate 80 with outer gloss layer 82 followed by coating the other side of the substrate 80 with a coextrusion of the specialty nylon oxygen barrier layer 84, oxygen barrier layer 86, tie layer 88, and inner product contact layer 90. While this is the preferred method of making the laminate of FIG. 5, other possible methods exist within the scope of the invention.

Referring to FIG. 6, a paperboard substrate 100, an outer gloss layer 102, a polyolefin layer 104, a tie layer 106, a barrier layer 108, a tie layer 110, and an inner product layer 112 are consistent with layers 20, 22, 30, 32, 34, 36, and 38, respectively, of FIG. 2. In this case, however, the barrier layer 108 must be a specialty nylon layer (as defined in layer 14 of FIG. 1). A coating weight is about 0.5-10 lbs., and preferably about 2-5 lbs.

In the laminate of FIG. 2, the inner product contact layer 38 is generally equivalent in coat weight to polyolefin layer 30 (i.e., the five layer coextrusion is symmetrical). However, in the inner product contact layer 112 of FIG. 6, this may or may not be the case. Coating weight of the inner product contact layer 112 may be about 1-20 lbs., preferably about 8-15 lbs., and most preferably about 12 lbs.

The laminate of FIG. 6 could be produced by coating one side of the paperboard substrate 100 with the outer gloss layer 102 followed by coating the other side of the substrate 100 with the coextrusion of polyolefin layer 104, the tie layer 106, the barrier layer 108, the tie layer 110, and the inner contact layer 112. Alternatively, the laminate of FIG. 6 could be produced by coating one side of the paperboard substrate 100 with the outer gloss layer 102 followed by coating the other side of the paperboard substrate 100 with the polyolefin layer 104, followed by a coextrusion of the tie layer 106, and the barrier layer 108, and the tie layer 110, and subsequently followed by a coating of layer inner product contact layer 112. These are just two preferred methods of producing the laminate of FIG. 6; other methods of manufacturing the laminates are within the scope of the invention.

Barrier layers 124 and 128 are identical and are formed from a polyamide such as nylon 6, nylon 66, nylon 10, nylon 6-10, or nylon 12 or a specialty nylon material (as defined in layer 14 of FIG. 1). Coating weight is about 1-15 lbs., and preferably about 5-10 lbs.

Barrier layer 126 is another barrier layer. When barrier layers 124 and 128 do not contain specialty nylon, barrier layer 126 must contain a specialty nylon as defined for barrier layer 14 of FIG. 1. When layers 124 and 128 do contain specialty nylon, layer 126 may be formed from any of the materials listed for barrier layer 34 of FIG. 2 (when layer 34 is not a specialty nylon). Coating weight of the barrier layer 126 is about 0.5-10 lbs., and preferably about 3-6 lbs.

Tie layers 130 and 134 have coating weights of about 1-6 lbs., and preferably about 4 lbs. A final barrier layer 132 may be formed from either a specialty nylon (as defined for layer 14 of FIG. 1) or may be formed from any of the materials listed for layer 34 of FIG. 2 (when layer 34 is not a specialty nylon). Coating weight is about 0.5-5 lbs., and preferably about 2-3 lbs.

The inner product contact layer 136 has a coating weight may be about 1-30 lbs., and preferably about 4-10 lbs. Preferably, the inner product coating layer 136 is made of a polyolefin polymer; more preferably, a polyethylene; and most preferably, a low-density polyethylene.

In the laminate of FIG. 7, at least one of the three “barrier” layers 124, 126, and 128 must contain a specialty nylon. The laminate would be produced by coating one side of the paperboard substrate 120 with outer gloss layer 122 followed by coating the other side of the substrate with a coextrusion of barrier layers 124, 126, and 128, followed by another coextrusion of tie 130, barrier layer 132, and tie layer 134, and subsequently followed by a coating of the inner product conduct layer 136. This is just one way of producing the laminate of FIG. 7 and should not be considered limiting within the scope of the invention.

The following examples are provided for further illustrating the invention, but are not to be construed as limitation thereof.

### EXAMPLE 1

Structures consistent with the format of FIG. 1 were produced using 12 lbs. low density polyethylene in outer gloss layer 12, 5 lbs. nylon in barrier layer 14, 1.5 lbs. maleic anhydride tie in tie layer 16, and 14 lbs. low density polyethylene in the inner product contact layer 18. Structure 1 contains an 80% MXD6/MXDI and 20% nylon 6 blend in barrier layer 14, Structure 2 contains an 80% MXD6 and 20% nylon 6 blend in barrier layer 14, and Structure 3 contains nylon 6 alone in barrier layer 14.

The oxygen transmission rate (cc/100 in²-day-atm) of each laminate was measured at 23° C./50% RH and 23° C./80% RH using a MOCON instrument. Results are shown in the table below.

| Laminate | OTR at 23° C./50% RH | OTR at 23° C./80% RH |
|---|---|---|
| Structure 1 | 0.22 | 0.27 |
| Structure 2 | 0.22 | 0.25 |
| Structure 3 | 0.51 | 2.62 |

The oxygen transmission rate (OTR) results are equivalent for Structure 1 and Structure 2. The OTR of Structure 3, which does not contain a specialty nylon, is significantly poorer.

### EXAMPLE 2

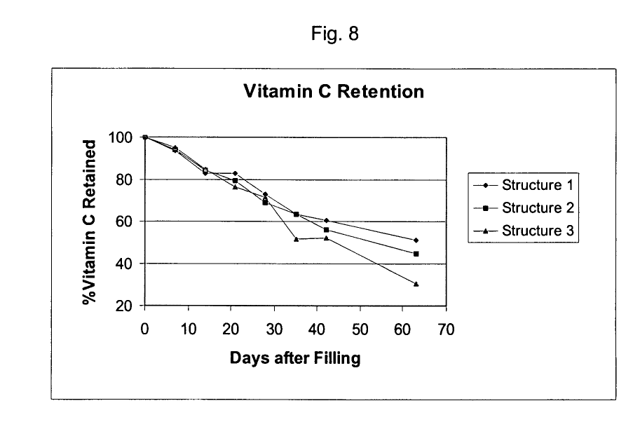

The laminates of Example 1 were converted into liter gable top cartons and filled with orange juice. The cartons were stored at refrigerated conditions and tested periodically across a sixty-three (63) day shelf life for vitamin C retention. The percent vitamin C retained in the orange juice is depicted in FIG. 8. Vitamin C retention was 6% and 20% higher in Structure 1 cartons compared to Structures 2 and 3, respectively.

### EXAMPLE 3

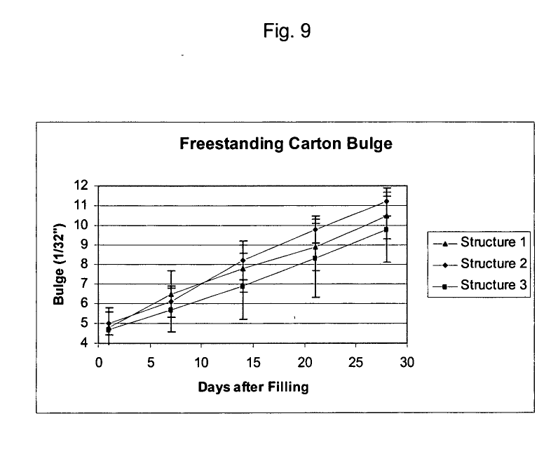

Cartons made from Structures 1, 2, and 3 of Example 2 were tested for carton bulge across a twenty-eight (28) day period. The cartons were filled with skim milk and stored freestanding (i.e., not touching the adjacent cartons) at refrigerated conditions. The carton bulge is the average of measurements taken in both the side-to-side and gable-to-gable dimensions. All results are statistically equivalent for a given test day as shown by the overlapping error bars in FIG. 9. The specialty nylon materials in Structures 1 and 2 show a comparable level of bulge resistance to standard nylon 6 in Structure 3.

### EXAMPLE 4

Structure 1 of Example 1 was also compared to a laminate structure 4 produced in accordance with FIG. 1 in which barrier layer 14 included 100% MXD6/MXDI material and a laminate structure 5 produced in accordance with FIG. 2 in which barrier layer 24 included 5 lbs. nylon 6 and barrier layer 34 included 3 lbs. ethylene vinyl alcohol (EVOH). The EVOH used contains 29 mole % ethylene. Structure 5 is consistent with a commercial carton in use today for refrigerated orange juice packaging.

The oxygen transmission rate (cc/100 in²-day-atm) of each laminate was measured at 23° C./50% RH and 23° C./80% RH. Results are shown in the table below.

| Laminate | OTR at 23° C./50% RH | OTR at 23° C./80% RH |
|---|---|---|
| Structure 1 | 0.22 | 0.27 |
| Structure 4 | 0.11 | 0.15 |
| Structure 5 | 0.016 | 0.11 |

From structure 4, it can be seen that the oxygen barrier improves when the MXD6/MXDI material is processed without the addition of nylon 6 (as in Structure 1). In addition, at the higher relative humidity test condition, the oxygen barrier advantage of the EVOH material in Structure 5 is significantly diminished compared to the specialty nylon materials.

### EXAMPLE 5

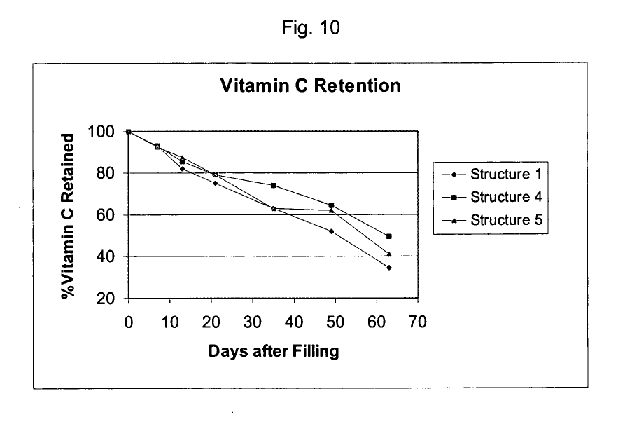

The laminates of Example 4 were converted into liter gable top cartons and filled with orange juice. The cartons were stored at refrigerated conditions and tested periodically across a 63-day shelf life for vitamin C retention. The percent vitamin C retained in the orange juice is depicted in FIG. 10. Vitamin C retention was 15% and 8% higher in Structure 4 cartons compared to Structures 1 and 5, respectively, at the end of the study.

For comparison, materials costs for structure 1 and structure 4 are 18% and 13% lower, respectively, than materials costs for structure 5. An added advantage is laminate structure simplification as structure 1 and structure 4 include three layers on the product contact side of the laminate whereas structure 5 includes eight layers on the product contact side of the laminate.

### EXAMPLE 6

Cast films were produced from the MXD6/MXDI material alone and in blends with other nylon materials using a single screw lab extruder. The melt temperature was held constant at 550° F. The barrel pressure and motor load were monitored for each film at equivalent screw speed. An oxygen transmission rate (cc-mil/100 in²-day) was then measured at 23° C./80% RH. Results are shown in the table below. All dry blend ratios are listed as weight percentages.

| | | | | OTR |
|---|---|---|---|---|
| | | BARREL | Motor | (cc-mil/ |
| | | PRESSURE | Load | 100 in2- |
| Material 1 | MATERIAL 2 | (psi) | (Amps) | day) |
| 100% MXD6/MXDI | — | 140 | 4.5 | 0.38 |
| 80% MXD6/MXDI | 20% Nylon 6 | 30 | 2 | 1.14 |
| 80% MXD6/MXDI | 20% Amorphous | 70 | 4.5 | 0.48 |
| | Nylon | | | |
| 80% MXD6/MXDI | 20% Nylon | 80 | 3.5 | 0.29 |
| | Nanocomposite | | | |

While the addition of 20% nylon 6 resulted in a reduction in pressure and motor load, the detrimental impact to OTR was readily observed. The use of 20% amorphous nylon resulted in a modest improvement in processability without greatly affecting the film OTR. Finally, the addition of 20% nylon 6 nanocomposite surprisingly exhibited a favorable improvement in both processability and OTR.

What is claimed is:

1. An oxygen barrier laminate, comprising:
a barrier layer including a partially aromatic nylon;
a polyolefin layer; and
a tie layer of an adhesive tie material bonding said barrier layer and said layer of polyolefin.

2. The oxygen barrier laminate according to claim 1, wherein said barrier layer includes an MXD6/MXDI material.

3. The oxygen barrier laminate according to claim 2, wherein said barrier layer includes a blend of MXD6/MXDI and nylon 6.

4. The oxygen barrier laminate according to claim 1, wherein said tie layer is an ethylene based copolymer modified with maleic anhydride functional groups.

5. The oxygen barrier laminate according to claim 1, wherein said polyolefin layer is polyethylene.

6. The oxygen barrier laminate according to claim 5, wherein said polyethylene is a low-density polyethylene.

7. An oxygen barrier laminate, comprising:
a paperboard substrate having an exterior and an interior surface;
a first polyolefin layer coated on said exterior surface of said paperboard substrate;
a partially aromatic nylon layer coated on said interior surface of said paperboard substrate;
a tie layer of an adhesive material; and
a second polyolefin layer forming a product contact surface.

8. The oxygen barrier laminate according to claim 7, wherein said partially aromatic nylon layer includes an MXD6/MXDI material.

9. The oxygen barrier laminate according to claim 8, wherein said partially aromatic nylon layer includes a blend of MXD6/MXDI and nylon 6.

10. The oxygen barrier laminate according to claim 7, wherein said tie layer is an ethylene based copolymer modified with maleic anhydride functional groups.

11. The oxygen barrier laminate according to claim 7 wherein, at least one of said polyolefin layers is polyethylene.

12. The oxygen barrier laminate according to claim 11, wherein said polyethylene is a low-density polyethylene.

13. An oxygen barrier laminate, comprising:
a paperboard substrate having an exterior and an interior surface;
a first polyolefin layer coated on said exterior surface of said paperboard substrate;
a polyamide coated on said interior surface of said paperboard substrate;
a barrier layer of partially aromatic nylon disposed interior to said polyamide layer; and
a second polyolefin layer forming a product contact surface.

14. The oxygen barrier laminate according to claim 13, wherein said partially aromatic nylon layer includes an MXD6/MXDI material.

15. The oxygen barrier laminate according to claim 14, wherein said partially aromatic nylon layer includes a blend of MXD6/MXDI and nylon 6.

16. The oxygen barrier laminate according to claim 13, wherein at least one of said polyolefin layers is polyethylene.

17. The oxygen barrier laminate according to claim 16, wherein said polyethylene is a low-density polyethylene.

18. A blank for use in producing a container for juices, tea, and other beverages constructed from the laminate according to claim 7.

19. A blank for use in producing a container for juices, tea, and other beverages constructed from the laminate according to claim 13.

20. A container for juices, tea, and other beverages constructed from the laminate according to claim 7.

21. A container for juices, tea, and other beverages constructed from the laminate according to claim 13.
